(19) United States
(12) Patent Application Publication
(10) Pub. No.: US 2023/0302926 A1
(43) Pub. Date: Sep. 28, 2023

(54) ELECTRIC VEHICLES AND WIRELESS CHARGING SYSTEMS

(71) Applicants: HYUNDAI MOTOR COMPANY, Seoul (KR); KIA CORPORATION, Seoul (KR)

(72) Inventors: Keon Chang Lee, Hwaseong-si (KR); Ki Beom Lee, Seoul (KR)

(73) Assignees: HYUNDAI MOTOR COMPANY, Seoul (KR); KIA CORPORATION, Seoul (KR)

(21) Appl. No.: 17/971,944

(22) Filed: Oct. 24, 2022

(30) Foreign Application Priority Data
Mar. 23, 2022 (KR) 10-2022-0036261

(51) Int. Cl. B60L 53/126; B60L 53/30; B60L 53/66

(52) U.S. Cl. CPC B60L 53/126; B60L 53/305; B60L 53/66

(57) ABSTRACT

An electric vehicle and a wireless charging system are disclosed. The wireless charging system includes a processor and a communication device. The processor is configured to search for a platooning string around an electric vehicle, to control the electric vehicle to join the searched platooning string based on a vehicle state and driving information of vehicles in the platooning string, and to receive wireless charging, when receiving a wireless charging request from the electric vehicle. The communication device is configured to perform wireless communication with the electric vehicle and the vehicles in the platooning string.

### CROSS-REFERENCE TO RELATED APPLICATION

This application claims priority to and the benefit of Korean Patent Application No. 10-2022-0036261, filed in the Korean Intellectual Property Office on Mar. 23, 2022, the entire contents of which are incorporated herein by reference.

### BACKGROUND OF THE DISCLOSURE

### (a) Field of the Disclosure

The present disclosure relates to an electric vehicle and a wireless charging system, and more particularly, to a wireless charging technique for a non-platooning electric vehicle using a platooning string.

### (b) Description of the Related Art

An electric vehicle is a vehicle driven by rotating a motor with electricity accumulated in a vehicle battery. Accordingly, the electric vehicle must visit an electric charging station to charge the battery when the battery needs to be charged.

Although the supply of electric vehicles is increasing every year, the supply of electric vehicle charging stations is not keeping up with it, raising the problem of expanding the supply of electric vehicle charging stations.

However, a time required to charge the battery of an electric vehicle takes more time than that of gasoline and diesel vehicles, and a long standby time is required for battery charging, so there is a need to respond to changes in road conditions and vehicle driving methods in the charging method of electric vehicles.

Furthermore, a flexible communication method that considers mobility of the vehicle is required for the charging method of the electric vehicle.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

Various aspects of the present disclosure are directed to providing an electric vehicle and a wireless charging system configured for enabling autonomous an electric vehicle that requires rapid charging to join a platooning string and to perform wireless inter-vehicle charging.

The technical objects of the present disclosure are not limited to the objects mentioned above. Other technical objects not mentioned may be clearly understood by those having ordinary skill in the art from the description of the claims.

An embodiment of the present disclosure provides a wireless charging system, including a processor configured to search for a platooning string around an electric vehicle and configured to control the electric vehicle to join the searched platooning string based on a vehicle state and driving information of vehicles in the platooning string and to receive wireless charging, when receiving a wireless charging request from the electric vehicle. The wireless charging system also includes a communication device configured to perform wireless communication with the electric vehicle and the vehicles in the platooning string.

In an embodiment of the present disclosure, the communication device may be configured to receive the vehicle state and the driving information from the electric vehicle and the vehicles in the platooning string.

In an embodiment of the present disclosure, the processor may be configured to determine a vehicle with most remaining battery power among the vehicles in the platooning string.

In an embodiment of the present disclosure, the processor may be configured to determine whether a target arrival time is satisfied at a time of maximum required charging, which is a charging request amount required to travel to a destination where the electric vehicle is able to be charged when there is no charging station positioned near a driving path of the electric vehicle, by using remaining battery power of the vehicle with the most remaining battery power.

In an embodiment of the present disclosure, the processor may be configured to select a point immediately behind the vehicle with the most remaining battery power as a joining point when the target arrival time is satisfied, to transmit information related to the joining point to the electric vehicle, and to control the electric vehicle to receive the wireless charging from the vehicle with the most remaining battery power.

In an embodiment of the present disclosure, the processor may be configured to determine whether there is a vehicle that satisfies the target arrival time when the vehicle with the most remaining battery power among the vehicles in the platooning string does not satisfy the target arrival time, or when minimum required charging, which is a charging request amount for the electric vehicle to move to a nearby charging station positioned near a driving path of the electric vehicle, is performed by using remaining battery power of vehicles other than the vehicle with the most remaining battery power among the vehicles in the platooning string.

In an embodiment of the present disclosure, the processor may be configured to select a point behind the vehicle that satisfies the target arrival time at a time of the minimum required charging as a joining point when there is the vehicle that satisfies the target arrival time at the time of the minimum required charging. The processor may be also configured to transmit information related to the joining point to the electric vehicle. The processor maybe also configured to control the electric vehicle to receive wireless charging from the vehicle that satisfies the target arrival time when the minimum required charging is performed.

In an embodiment of the present disclosure, the processor may be configured to determine whether there is a vehicle newly joining the platooning string. The processor may be configured to do so when the target arrival time is not satisfied when maximum required charging is performed by using remaining battery power of the vehicle with the most remaining battery power among the vehicles in the platooning string, or when the target arrival time is not satisfied when minimum required charging is performed by using remaining battery powers of vehicles other than the vehicle with the most remaining battery power among the vehicles in the platooning string.

In an embodiment of the present disclosure, the processor may be configured to determine remaining battery power of the vehicle newly joining the platooning string when there is the vehicle newly joining the platooning string, to determine whether the target arrival time is satisfied when the maximum required charging of the electric vehicle is performed or whether the target arrival time is satisfied when the minimum required charging of the electric vehicle is performed.

In an embodiment of the present disclosure, the processor may be configured to select one or more vehicles with a minimum chargeable amount that is greater than a predetermined reference value from among the vehicles in the platooning string. The processor maybe configured to do so when the target arrival time is not satisfied when maximum required charging is performed by using remaining battery power of the vehicle with the most remaining battery power among the vehicles in the platooning string, when the target arrival time is not satisfied when the minimum required charging is performed by using remaining battery powers of vehicles other than the vehicle with the most remaining battery power among the vehicles in the platooning string, and when there is no vehicle newly joining the platooning string.

In an embodiment of the present disclosure, the processor, when the one or more vehicles with the minimum chargeable amount that is greater than the predetermined reference value among the vehicles in the platooning string are set as a first vehicle and a second vehicle, may be configured to select a point behind the first vehicle as a first joining point, may be configured to select a point behind the second vehicle as a second joining point, and may be configured to control the electric vehicle to receive wireless charging through the first vehicle at the first joining point, and to then move to the second joining point and to receive wireless charging through the second vehicle.

An embodiment of the present disclosure provides an electric vehicle including a processor configured to request a wireless charging system to perform wireless charging and, when information related to a joining point in a platooning string is received from the wireless charging system, to control the electric vehicle to move to the joining point, to join the platooning string, and to receive wireless charging from a vehicle in front. The electric vehicle also includes a communication device configured to perform wireless communication with the wireless charging system and vehicles in the platooning string.

In an embodiment, the processor may be configured to control the vehicle depending on a command of a leading vehicle of the platooning string when it joins the platooning string.

In an embodiment of the present disclosure, the processor may be configured to perform braking control simultaneously with the vehicles in the platooning string and to stop the wireless charging. The processor may be configured to do so when receiving an emergency braking command from the leading vehicle of the platooning string during wireless charging after the joining of the platooning string.

In an embodiment of the present disclosure, the processor, depending on the first joining point and the second joining point received from the wireless charging system, may be configured to control the vehicle to first move to the first joining point, to join the platooning string, and to receive first wireless charging from a vehicle in front, and when the first wireless charging is completed, to control the vehicle to leave the platooning string for a while, to move to a second joining point, to join the joining string, and to receive second wireless charging from a vehicle in front.

An embodiment of the present disclosure provides an electric vehicle, which performs platooning, may be configured to adjust an inter-vehicle distance for allowing a non-platooning electric vehicle to join a platooning string when receiving a request for the joining of the non-platooning electric vehicle and wireless charging from a wireless charging system during platooning.

In an embodiment of the present disclosure, the electric vehicle may readjust the platooning string when the wireless charging is completed after the non-platoon electric vehicle joins the platooning string and it leaves the platooning string.

In an embodiment of the present disclosure, the electric vehicle increases an inter-vehicle distance at a point which the non-platooning electric vehicle in the platooning string intends to join when the non-platooning electric vehicle joins the platooning string, receives first wireless charging, leaves the platooning string, and then wants to join it behind another vehicle in the platooning string for second wireless charging.

In an embodiment of the present disclosure, the electric vehicle, while providing wireless charging to the non-populated electric vehicle, may stop providing the wireless charging and performs emergency braking when an emergency braking command is received from a leading vehicle.

According to the present technique, it is possible to facilitate wireless charging by enabling autonomous an electric vehicle that requires rapid charging to join a platooning string and to perform wireless inter-vehicle charging. Thus, user convenience may be increased.

Furthermore, various effects that can be directly or indirectly identified through this document may be provided.

### BRIEF DESCRIPTION OF THE DRAWINGS

FIG. 1A illustrates a block diagram showing a configuration of a system for wirelessly charging an electric vehicle according to an embodiment of the present disclosure.

FIG. 1B illustrates a detailed schematic diagram of an electric vehicle according to an embodiment of the present disclosure.

FIG. 2 illustrates an overall configuration diagram for wireless charging according to an embodiment of the present disclosure.

FIG. 3 illustrates a view for describing a method of joining a platooning string of an electric vehicle requesting charging according to an embodiment of the present disclosure.

FIG. 4 illustrates a view for describing a response method when emergency braking occurs during wireless charging according to an embodiment of the present disclosure.

FIGS. 5A-5C each illustrate a joining method of an electric vehicle requesting charging after leaving a platooning string according to an embodiment of the present disclosure.

FIG. 6 illustrates a flowchart showing a wireless charging method of an electric vehicle according to an embodiment of the present disclosure.

FIG. 7 illustrates a computing system according to an embodiment of the present disclosure.

### DETAILED DESCRIPTION OF THE EMBODIMENTS

Hereinafter, some embodiments of the present disclosure are described in detail with reference to drawings. It should be noted that in adding reference numerals to constituent elements of each drawing, the same or equivalent constituent elements have the same reference numerals as possible even though they are indicated on different drawings. Furthermore, in describing embodiments of the present disclosure, when it is determined that detailed descriptions of related well-known configurations or functions interfere with understanding of the embodiments of the present disclosure, the detailed descriptions thereof have been omitted.

In describing constituent elements according to various embodiments of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those having ordinary skill in the technical field to which an embodiment of the present disclosure pertains (those having ordinary skill in the art) unless they are differently defined. Terms defined in a generally used dictionary shall be construed to have meanings matching those in the context of a related art and shall not be construed to have idealized or excessively formal meanings unless they are clearly defined in the present specification. When a component, device, element, or the like of the present disclosure is described as having a purpose or performing an operation, function, or the like, the component, device, or element should be considered herein as being “configured to” meet that purpose or to perform that operation or function.

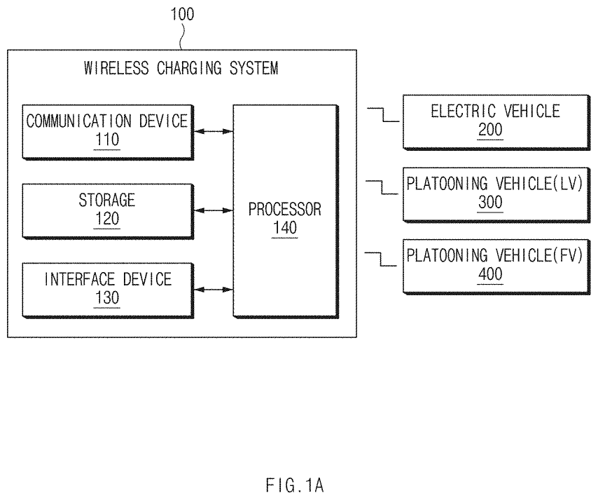

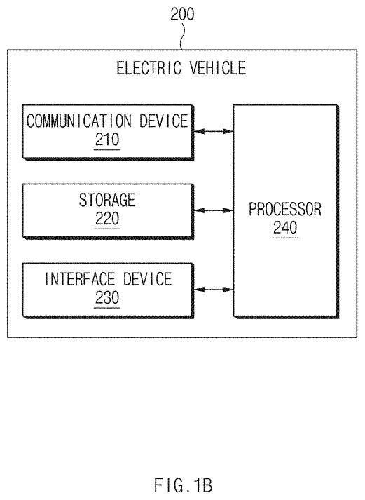

Hereinafter, various embodiments of the present disclosure are described in detail with reference to FIGS. 1-7.

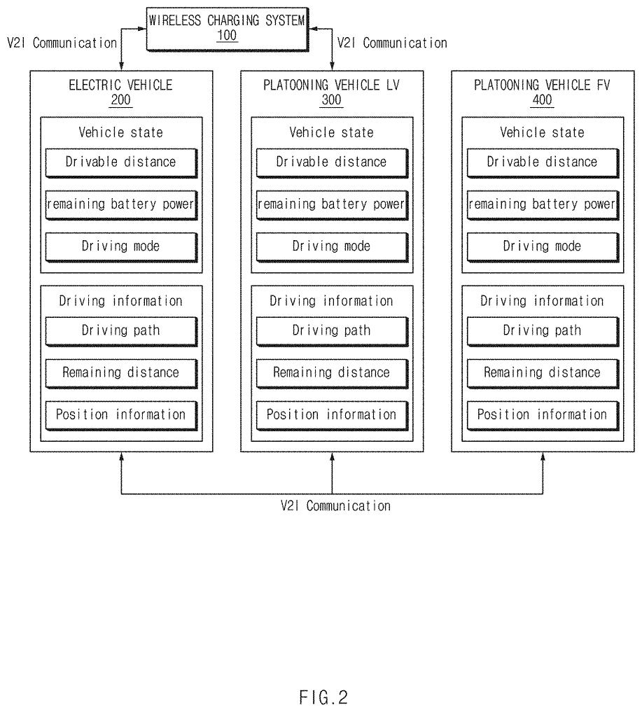

FIG. 1A illustrates a block diagram showing a configuration of a system for wirelessly charging an electric vehicle according to an embodiment of the present disclosure. FIG. 1B illustrates a detailed schematic diagram of an electric vehicle according to an embodiment of the present disclosure. FIG. 2 illustrates an overall configuration diagram for wireless charging according to an embodiment of the present disclosure.

Referring to FIG. 1A, a system for wireless charging of an electric vehicle according to an embodiment of the present disclosure may include a wireless charging system 100, an electric vehicle 200 requesting wireless charging, and platooning vehicles 300 and 400.

The wireless charging system 100 according to an embodiment of the present disclosure may enable the wireless charging system 100 and the platooning vehicles 300 and 400 to share information with each other through wireless communication and may enable the electric vehicle 200 to join a platooning string and to perform wireless charging by the platooning vehicles 300 and 400.

The wireless charging system 100 may be implemented as a control system, a server, etc. and may be implemented as a separate server for remote control or platooning control.

The wireless charging system 100 may control an arrangement of a platooning string by recognizing performance of each vehicle in the platooning string and a status and driving information of each vehicle and may select a joining point for an electric vehicle that has requested wireless charging by determining remaining battery power of the vehicles in the platooning string.

In other words, when receiving a wireless charging request from the electric vehicle 200, the wireless charging system 100 may search for a platooning string around the electric vehicle 200 and may control the electric vehicle 200 to join the platooning string and to receive wireless charging.

To this end, the wireless charging system 100 may include a communication device 110, a storage 120, an interface device 130, and a processor 140.

The communication device 110 is a hardware device implemented with various electronic circuits to transmit and receive signals through a wireless or wired connection. As an example, the communication device 110 may perform V2I, V2V, and V2X communication with the wireless charging system 100 and the platooning vehicles 300 and 400 as illustrated in FIG. 2.

The storage 120 may store data and/or algorithms required for the processor 140 to operate, and the like. As an example, the storage 120 may store vehicle state information and driving information of the electric vehicle 200 and the platooning vehicles 300 and 400 received through the communication device 110.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may output a control state and result for management of platooning vehicles such that a manager can check it.

The processor 140 may be electrically connected to the communication device 110, the storage 120, the interface device 130, and the like, may electrically control each component, and may be an electrical circuit that executes software commands. Thus, various data processing and calculations described below may be performed.

The processor 140 may process a signal transferred between components of the wireless charging system 100 and may perform overall control such that each of the components can perform its function normally.

The processor 140 may be implemented in the form of hardware, software, or a combination of hardware and software or may be implemented as microprocessor, and It may be, e.g., an electronic control unit (ECU), a micro controller unit (MCU), or other sub-controllers mounted in the vehicle.

In other words, when receiving a wireless charging request from the electric vehicle 200, the processor 140 may search for a platooning string around the electric vehicle 200 and may control the electric vehicle 200 to join searched platooning string based on a vehicle state and driving information of vehicles in the platooning string and to receive wireless charging.

The processor 140 may determine a vehicle with most remaining battery power among vehicles in the platooning string and may determine whether a target arrival time at a time of maximum required charging is satisfied by using the remaining battery power of the vehicle with the most remaining battery power. In the instant case, when there is no charging station positioned near a driving path of the electric vehicle 200, the maximum required charging is a charging request amount required to travel to a destination where the electric vehicle 200 can be charged.

When the target arrival time at the time of the maximum required charging is satisfied using the remaining battery power of the vehicle with the most remaining battery power, the processor 140 selects a point immediately behind the vehicle with the most remaining battery power as the joining point The processor 140 may control the electric vehicle 200 to receive wireless charging from the vehicle the most remaining battery power by transmitting information related to the joining point to the electric vehicle 200 through the communication device 110.

Furthermore, the processor 140 may determine whether there is a vehicle that satisfies the target arrival time when the vehicle with the most remaining battery power among the vehicles in the platooning string does not satisfy the target arrival time, or when minimum required charging is performed by using remaining battery power of vehicles other than the vehicle with the most remaining battery power among the vehicles in the platooning string. In the instant case, the minimum required charging indicates a charging request amount for the electric vehicle 200 to move to a nearby charging station positioned near a driving path of the electric vehicle 200.

When there is a vehicle that satisfies the target arrival time at the time of the minimum required charging, the processor 140 may select a point behind the vehicle that satisfies the target arrival time at the time of the minimum required charging as the joining point, may transmit information related to the joining point to the electric vehicle 200, and may control the electric vehicle 200 to receive wireless charging from the vehicle that satisfies the target arrival time when the minimum required charging is performed.

On the other hand, the processor 140 determines whether there is a vehicle newly joining the platooning string. The processor 140 does so when the target arrival time is not satisfied when the maximum required charging is performed by using the remaining battery power of the vehicle with the most remaining battery power among the vehicles in the platooning string. Or the processor 140 does so when the target arrival time is not satisfied when the minimum required charging is performed by using remaining battery powers of vehicles other than the vehicle with the most remaining battery power among the vehicles in the platooning string.

Accordingly, when there is a vehicle newly joining the platooning string, the processor 140 may determine remaining battery power of the vehicle newly joining the platooning string to determine whether the target arrival time is satisfied when the maximum required charging of the electric vehicle 200 is performed or whether the target arrival time is satisfied when the minimum required charging of the electric vehicle 200 is performed.

On the other hand, the processor 140 may select at least one vehicle with a minimum chargeable amount that is greater than a predetermined reference value from among the vehicles in the platooning string. The processor 140 may do so (1) when the target arrival time is not satisfied when the maximum required charging is performed by using the remaining battery power of the vehicle with the most remaining battery power among the vehicles in the platooning string, (2) when the target arrival time is not satisfied when the minimum required charging is performed by using remaining battery powers of vehicles other than the vehicle with the most remaining battery power among the vehicles in the platooning string, and/or (3) when there is no vehicle newly joining the platooning string. In the instant case, the minimum chargeable amount indicates a battery charging amount that can be charged by using remaining battery power, except for battery power required for a platooning vehicle to drive to its destination, in the remaining battery power of the platooning vehicle.

When one or more vehicles with a minimum chargeable amount that is greater than a predetermined reference value among the vehicles in the platooning string are set as a first vehicle and a second vehicle, the processor 140 may select a point behind the first vehicle as a first joining point and select a point behind the second vehicle as a second joining point. The processor 140 may also control the electric vehicle 200 to receive wireless charging through the first vehicle at the first joining point and to then move to the second joining point and to receive wireless charging through the second vehicle.

Referring to FIG. 1B, the electric vehicle 200 may include a communication device 210, a storage 220, an interface device 230 and a processor 240.

The communication device 210 is a hardware device implemented with various electronic circuits to transmit and receive signals through a wired connection and may transmit and receive information based on in-vehicle devices and in-vehicle network communication techniques. As an example, the in-vehicle network communication techniques may include controller area network (CAN) communication, local interconnect network (LIN) communication, flex-ray communication, and the like. As an example, the communication device 210 may perform V2I, V2V, and V2X communication with the wireless charging system 100 and the platooning vehicles 300 and 400 as illustrated in FIG. 2.

The storage 220 may store data and/or algorithms required for the processor 240 to operate, and the like. As an example, the storage 220 may receive information related to the joining point from the wireless charging system 100 through the communication device 210 and may receive a command signal from a leading vehicle LV among platooning vehicles.

The storage 220 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 230 may include an input means for receiving a control command from a user and an output means for outputting an operating state and result (e.g., a charging state, a remaining battery amount, etc.) of the host vehicle. Herein, the input means may include a key button and may include a mouse, a joystick, a jog shuttle, a stylus pen, and the like. Furthermore, the input means may include a soft key implemented on the display.

The output device may include a display and may also include a voice output means such as a speaker. In the instant case, when a touch sensor formed of a touch film, a touch sheet, or a touch pad is provided on the display, the display may operate as a touch screen and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 240 may be electrically connected to the communication device 210, the storage 220, the interface device 230, and the like, may electrically control each component, and may be an electrical circuit that executes software commands. Thus, various data processing and calculations described below may be performed.

The processor 240 may process a signal transferred between components of the electric vehicle 200 and may perform overall control such that each of the components can perform its function normally.

The processor 240 may be implemented in the form of hardware, software, or a combination of hardware and software or may be implemented as microprocessor. The processor 240 may be, e.g., an electronic control unit (ECU), a micro controller unit (MCU), or other sub-controllers mounted in the vehicle.

The processor 240 may request the wireless charging system 100 to perform wireless charging. When information related to the joining point in the platooning string is received from the wireless charging system, the processor 240 may control a vehicle to move to the joining point, to join the platooning string, and to receive wireless charging from a vehicle in front.

When the vehicle joins the platooning string, the processor 240 may control the vehicle depending on a command of a leading vehicle of the platooning string.

Furthermore, when receiving an emergency braking command from the leading vehicle of the platooning string during wireless charging after the joining of the platooning string, the processor 240 may perform braking control simultaneously with vehicles in the platooning string to stop the wireless charging.

The processor 240 may control the vehicle to first move to a first joining point, to join the platooning string and to receive first wireless charging from the vehicle in front. When the first wireless charging is completed, the processor 240 may control a vehicle to leave the platooning string for a while, to move to a second joining point, to join the joining string, and to receive second wireless charging from a vehicle in front, depending on the first joining point and the second joining point received from the wireless charging system.

When the platooning vehicle 300 is a leading vehicle LV and the platooning vehicle 400 is a following vehicle FV, when a request for the non-platooning electric vehicle 200 to join the platooning string and wireless charging is received from the wireless charging system during platooning, the leading vehicle LV may control an inter-vehicle distance between the platooning vehicles at the joining point of the electric vehicle 200 for the joining of the non-platooning electric vehicle 200. In other words, it is possible to increase the inter-vehicle distance between the platooning vehicles at each of the points.

The leading vehicle LV readjusts the platooning string when the wireless charging is completed after the non-platoon electric vehicle 200 joins the platooning and it leaves the platooning string.

The leading vehicle LV may increase an inter-vehicle distance at a point which the non-platooning electric vehicle 200 in the platooning string intends to join when the non-platooning electric vehicle 200 joins the platooning string, receives first wireless charging, leaves the platooning string, and then wants to join it behind another vehicle in the platooning string for second wireless charging.

When an emergency braking command is received from the leading vehicle while wireless charging is being provided to the non-platooning electric vehicle 200, the vehicle that provides wireless charging to the non-platooning electric vehicle 200 may stop providing wireless charging and perform emergency braking.

Although the present disclosure does not disclose a detailed configuration of the platooning vehicles 300 and 400, the platooning vehicles 300 and 400 also have a same configuration as that of the electric vehicle 200 and are driven by electric charging. Furthermore, the platooning vehicles 300 and 400 may each include a processor, a storage, a communication device, and an interface device, as in the electric vehicle 200 of FIG. 1B.

Referring to FIG. 2, the wireless charging system 100 performs V2I communication with the electric vehicle 200, and the electric vehicle 200 that needs charging requests the wireless charging system 100 to perform charging. In the instant case, the electric vehicle 200 may transmit a vehicle state and driving information of the electric vehicle 200 together to the wireless charging system 100.

Accordingly, the wireless charging system 100 may search a platooning string around the electric vehicle 200 to transmit joining position information, which is a joining point in the platooning string capable of wireless charging, to the electric vehicle 200.

Furthermore, the leading vehicle, which is the platooning vehicle 300, performs V2I communication with the wireless charging system 100. The wireless charging system 100 transmits a charging request signal to the leading vehicle 300 of the platooning string that is driving in a position closest to the electric vehicle 200 that has requested charging. When a chargeable signal is received from the lead vehicle 300, the wireless charging system 100 selects a vehicle that can perform charging from among the platooning string and determines a joining point by receiving a vehicle state and driving information of the platooning string from the vehicles in the platooning string.

When receiving a charging request signal from the wireless charging system 100, the leading vehicle 300 may transmit a chargeable signal or a non-chargeable signal to the wireless charging system 100 and may transmit the vehicle state and the driving information of the platooning string to the wireless charging system 100.

Furthermore, the leading vehicle 300 may perform V2V communication with the following vehicle 400 and may receive a vehicle state and driving information of the following vehicle 400 from the following vehicle 400 to transmit it to the wireless charging system 100. Furthermore, the leading vehicle 300 may transmit a command signal for platooning to the following vehicle 400.

Accordingly, the following vehicle 400 may control inter-vehicle distance adjustment, wireless charging activation, and the like depending on the command signal received from the leading vehicle 300.

Furthermore, the electric vehicle 200 may perform V2V communication with the leading vehicle 300 for joining the platooning string and may perform vehicle control depending on the command of the lead vehicle 300 after joining the platooning string.

Although not illustrated in FIG. 1 and FIG. 2, the electric vehicle 200 and the platooning vehicles 300 and 400 may each include a communication module for communication, a storage module, a processor, etc. and may further include at least one sensor for sensing vehicle surroundings.

As such, according to the present disclosure, it is possible to increase convenience of electric vehicle users as charging of electric vehicles is facilitated by providing vehicle-to-vehicle wireless charging of electric vehicles that require rapid charging in a platooning string of electric trucks when charging.

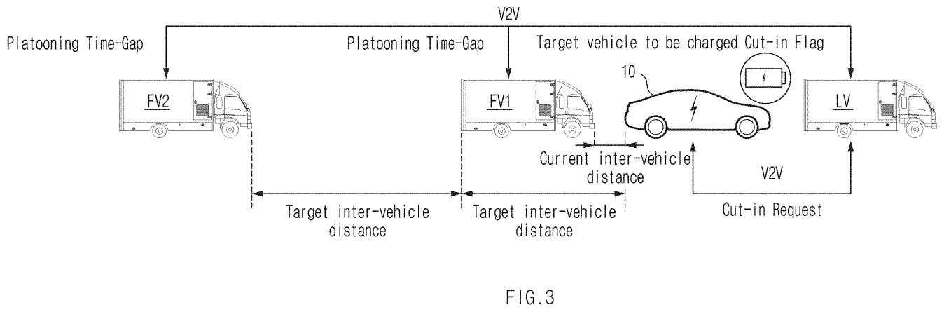

FIG. 3 illustrates a view for describing a method of joining a platooning string of an electric vehicle requesting charging according to an embodiment of the present disclosure.

Referring to FIG. 3, platooning vehicles LV, FV1, and FV2 may perform V2V communication and may adjust an inter-vehicle distance based on a time-gap. In the instant case, the time-gap indicates a time it takes to reach a target inter-vehicle distance when driving at a current speed of the vehicle. For example, when the time-gap is set to 0.5 sec when platooning is performed at 90 km/h, a minimum inter-vehicle distance of 12.5 m can be maintained.

When receiving joining point information from the wireless charging system 100, the electric vehicle 10 requesting charging makes a joining request (Cut-in) to the leading vehicle LV of the platooning string. In the instant case, the leading vehicle LV adjusts an inter-vehicle distance such that the electric vehicle 10 that has requested charging enters the target joining point by transferring a cut-in flag of the electric vehicle 10 that has requested charging to the following vehicles FV1 and FV2 and adjusting a platooning time gap. Accordingly, the electric vehicle 10 requesting charging may join the platooning string to perform wireless charging. In FIG. 3, an example of joining it behind the leading vehicle LV and receiving wireless charging from the lead vehicle LV is disclosed.

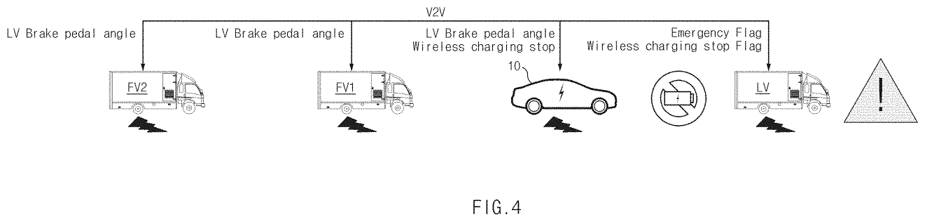

FIG. 4 illustrates a view for describing a response method when emergency braking occurs during wireless charging according to an embodiment of the present disclosure.

Referring to FIG. 4, the following vehicles FV1 and FV2 and the electric vehicle 10 receive brake pedal angle information from the leading vehicle LV and all vehicles in a platooning string brake simultaneously, when the electric vehicle that requested charging joins the platooning string behind the leading vehicle LV so that the leading vehicle LV transmits an emergency braking flag to the vehicles in the platooning string and the electric vehicle 10 to avoid a dangerous situation in front during wireless charging. In the instant case, for safety, the wireless charging of the electric vehicle 10 is stopped at the same time when the emergency braking flag is generated.

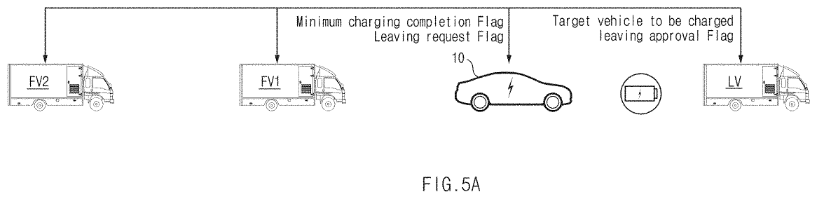

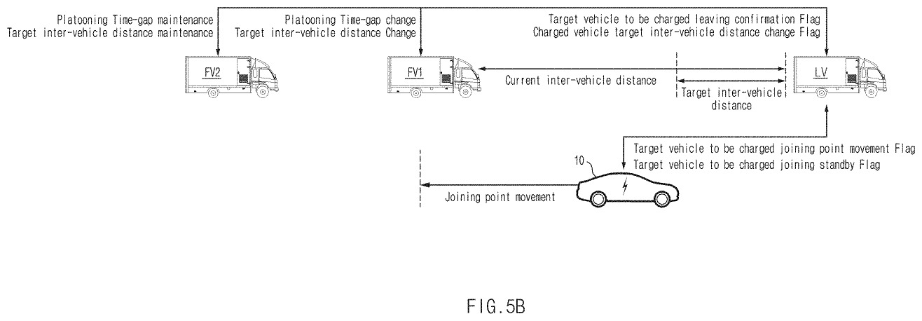

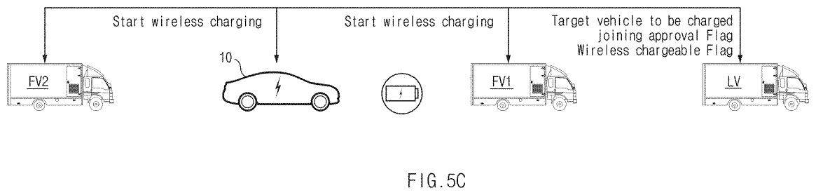

FIGS. 5A-5C each illustrate a joining method of an electric vehicle requesting charging after leaving a platooning string according to an embodiment of the present disclosure.

Referring to FIG. 5A, when minimum charging of the electric vehicle 10 is completed, the electric vehicle 10 transmits a minimum charging completion flag and a string-leaving flag to the leading vehicle LV.

Accordingly, the leading vehicle LV transmits a leaving-approval flag of the electric vehicle 10 to the electric vehicle 10 by determining a surrounding situation. In other words, the leading vehicle LV transmits the leaving-approval flag when there is no obstacle in a direction for the leaving of the electric vehicle 10.

Then, as illustrated in FIG. 5B, when receiving the leaving-approval flag from the leading vehicle LV, the electric vehicle 10 leaves the platooning string, moves to a next joining point, and waits for joining.

In the instant case, after the leaving of the electric vehicle 10, the leading vehicle LV changes the target inter-vehicle distance with the following vehicle FV1. Meanwhile, the leading vehicle LV changes the platooning time gap again for the joining of the electric vehicle 10 at the next joining point.

In other words, an inter-vehicle distance behind the following vehicle FV1, which is a next charging vehicle for the electric vehicle 10 to join, is secured by re-adjusting an inter-vehicle distance in the platooning string due to the leaving of the electric vehicle 10.

Referring to FIG. 5C, a configuration in which the electric vehicle 10 joins it behind the following vehicle FV1 to receive wireless charging from the following vehicle FV1 is disclosed.

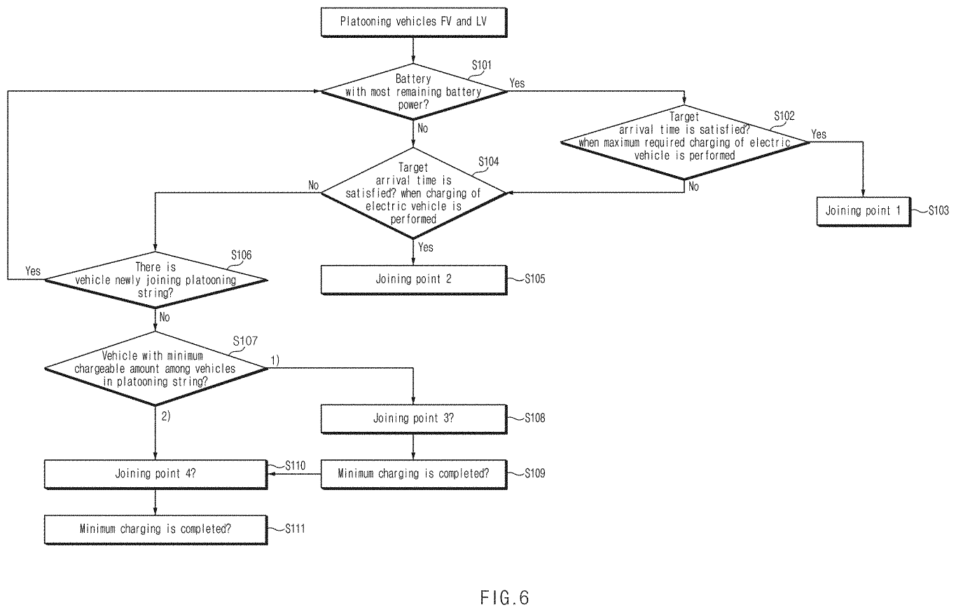

Hereinafter, a wireless charging method of an electric vehicle according to an embodiment of the present disclosure is described in detail with reference to FIG. 6. FIG. 6 illustrates a flowchart showing a wireless charging method of an electric vehicle according to an embodiment of the present disclosure.

Hereinafter, it is assumed that the wireless charging system 100 of FIG. 1 performs a process of FIG. 6. Furthermore, in the description of FIG. 6, it may be understood that operations described as being performed by each system are controlled by a processor of each of the systems.

Referring to FIG. 6, when a charging request is received from the electric vehicle, the wireless charging system 100 searches for a platooning string that is driving in a position closest to the electric vehicle and determines a vehicle with most remaining battery power by checking remaining battery power of the platooning vehicles (S101).

The wireless charging system 100 determines whether the vehicle can reach a destination within a target arrival time when maximum required charging is performed on the electric vehicle with maximum remaining battery power of the vehicle with the most remaining battery power among the platooning vehicles (S102). In the instant case, the maximum required charging refers to a requested amount of charging that is necessary for travel to a destination where charging can be safely performed when no charging station exists in a driving path and therearound.

When the target arrival time is satisfied during the maximum required charging, the wireless charging system 100 selects a rear point of the vehicle with most remaining battery power as a first joining point (Joining point 1) (S103).

Meanwhile, when remaining vehicles except for the vehicle with the most remaining battery power among the platooning vehicles in step S101 and the vehicle with the most remaining battery power among the platooning vehicles in step S102 do not satisfy the target arrival time for the maximum required charging of the electric vehicle, the wireless charging system 100 determines whether the target arrival time is satisfied during minimum required charging of the electric vehicle (S104). In the instant case, the minimum required charging refers to a requested amount of charging for travel to a nearby charging station positioned in a driving path and therearound.

Then, the wireless charging system 100 selects a rear of the vehicle that satisfies the arrival target time during the minimum required charging of the electric vehicle as a second joining point (Joining point 2) (S105).

On the other hand, when there is no vehicle that satisfies the target arrival time at a time of the minimum required charging of the electric vehicle among the vehicles in the platooning string, the wireless charging system 100 determines whether there is a new vehicle joining the platooning string (S106).

When there is a vehicle that newly joins the platooning string, the wireless charging system 100 repeats steps S101 to S106 based on the newly joined vehicle.

On the other hand, when there is no vehicle that newly joins it, the wireless charging system 100 determines a vehicle with most minimum chargeable amount among the vehicles in the platooning string (S107).

Then, the wireless charging system 100 selects a rear of the vehicle with the most minimum chargeable amount as a third joining point (Joining point 3) (S108) and selects a rear of the vehicle with a next most minimum chargeable amount among the vehicles in the platooning string as a fourth joining point (Joining point 4) (S110). In the instant case, when the minimum charging using the minimum chargeable amount of the vehicle is completed at the third joining point (S109), the wireless charging system 100 transmits a command signal to the electric vehicle such that the electric vehicle requesting charging moves to the fourth joining point.

Accordingly, the electric vehicle 200 may perform the first minimum charging at the third joining point and may move to the fourth joining point to perform the second minimum charging.

As such, when it is difficult to select the first joining point or second joining point and there is no vehicle newly joining the platooning string, i.e., when one of the vehicles in the platooning string is unable to perform the maximum or minimum required charging, the wireless charging system 100 selects a vehicle capable of performing the minimum charging among the vehicles in the platooning string. In the instant case, there may be a plurality of vehicles capable of performing the minimum charging, and the electric vehicle may sequentially receive the minimum charging from the vehicles capable of performing the minimum charging. In other words, when the electric vehicle joins the platooning string behind a firstly selected vehicle and the minimum charging is completed (S111), the electric vehicle may leave the platooning string and then may move behind a next vehicle to perform the minimum charging.

As such, according to the present disclosure, when a charging amount of the electric vehicle is insufficient while the electric vehicle drives, it is possible to minimize the hassle caused by such insufficient battery charging while driving by using V2V and V2I techniques. The techniques are used to search a string of platooning electric trucks positioned dose to a driving path of an electric vehicle that has requested charging and, by controlling the electric vehicle to join the selected platooning string, to perform wireless inter-vehicle charging while driving, and to drive to a destination where charging is possible.

Furthermore, according to the present disclosure, an effect can be further maximized when Hub to Hub logistics transportation of autonomous platooning electric truck is popularized, due to environmental pollution problems of internal combustion engine vehicles.

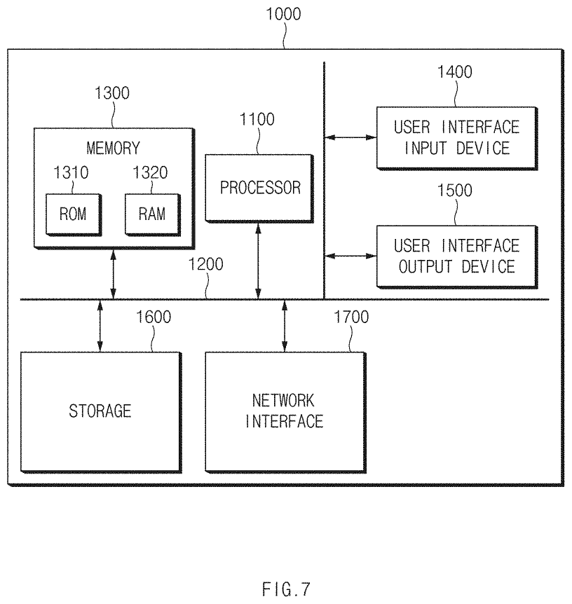

FIG. 7 illustrates a computing system according to an embodiment of the present disclosure.

Referring to FIG. 7, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

A storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description merely illustrates the technical idea of the present disclosure. Those having ordinary skill in the art to which the present disclosure pertains may make various modifications and variations without departing from the essential characteristics of the present disclosure.

Therefore, the embodiments disclosed in the present disclosure are not intended to limit the technical ideas of the present disclosure, but to explain them. The scope of the technical ideas of the present disclosure is not limited by these embodiments. The protection scope of the present disclosure should be interpreted by the claims below, and all technical ideas within the equivalent scope should be interpreted as being included in the scope of the present disclosure.

What is claimed is:

1. A wireless charging system comprising:
a processor configured to search for a platooning string around an electric vehicle and configured to control the electric vehicle to join the searched platooning string based on a vehicle state and driving information of vehicles in the platooning string and to receive wireless charging, when receiving a wireless charging request from the electric vehicle; and
a communication device configured to perform wireless communication with the electric vehicle and the vehicles in the platooning string.

2. The wireless charging system of claim 1, wherein
the communication device is configured to receive the vehicle state and the driving information from the electric vehicle and the vehicles in the platooning string.

3. The wireless charging system of claim 1, wherein
the processor is configured to determine a vehicle with most remaining battery power among the vehicles in the platooning string.

4. The wireless charging system of claim 3, wherein
the processor is configured to determine whether a target arrival time is satisfied at a time of maximum required charging, which is a charging request amount required to travel to a destination where the electric vehicle is able to be charged when there is no charging station positioned near a driving path of the electric vehicle, by using remaining battery power of the vehicle with the most remaining battery power.

5. The wireless charging system of claim 4, wherein
the processor is configured to select a point immediately behind the vehicle with the most remaining battery power as a joining point when the target arrival time is satisfied, to transmit information related to the joining point to the electric vehicle, and to control the electric vehicle to receive the wireless charging from the vehicle with the most remaining battery power.

6. The wireless charging system of claim 4, wherein
the processor is configured to determine whether there is a vehicle that satisfies the target arrival time when the vehicle with the most remaining battery power among the vehicles in the platooning string does not satisfy the target arrival time, or when minimum required charging, which is a charging request amount for the electric vehicle to move to a nearby charging station positioned near a driving path of the electric vehicle, is performed by using remaining battery power of vehicles other than the vehicle with the most remaining battery power among the vehicles in the platooning string.

7. The wireless charging system of claim 6, wherein
the processor is configured to select a point behind the vehicle that satisfies the target arrival time at a time of the minimum required charging as a joining point when there is the vehicle that satisfies the target arrival time at the time of the minimum required charging, to transmit information related to the joining point to the electric vehicle, and to control the electric vehicle to receive wireless charging from the vehicle that satisfies the target arrival time when the minimum required charging is performed.

8. The wireless charging system of claim 1, wherein
the processor is configured to determine whether there is a vehicle newly joining the platooning string,
when the target arrival time is not satisfied when maximum required charging is performed by using remaining battery power of the vehicle with the most remaining battery power among the vehicles in the platooning string, or
when the target arrival time is not satisfied when minimum required charging is performed by using remaining battery powers of vehicles other than the vehicle with the most remaining battery power among the vehicles in the platooning string.

9. The wireless charging system of claim 8, wherein
the processor is configured to determine remaining battery power of the vehicle newly joining the platooning string when there is the vehicle newly joining the platooning string, to determine whether the target arrival time is satisfied when the maximum required charging of the electric vehicle is performed or whether the target arrival time is satisfied when the minimum required charging of the electric vehicle is performed.

10. The wireless charging system of claim 1, wherein
the processor is configured to select one or more vehicles with a minimum chargeable amount that is greater than a predetermined reference value from among the vehicles in the platooning string,
when the target arrival time is not satisfied when maximum required charging is performed by using remaining battery power of the vehicle with the most remaining battery power among the vehicles in the platooning string,
when the target arrival time is not satisfied when minimum required charging is performed by using remaining battery powers of vehicles other than the vehicle with the most remaining battery power among the vehicles in the platooning string, and
when there is no vehicle newly joining the platooning string.

11. The wireless charging system of claim 10, wherein
the processor, when the one or more vehicles with the minimum chargeable amount that is greater than the predetermined reference value among the vehicles in the platooning string are set as a first vehicle and a second vehicle, is configured to
select a point behind the first vehicle as a first joining point,
select a point behind the second vehicle as a second joining point, and
control the electric vehicle to receive wireless charging through the first vehicle at the first joining point, and to then move to the second joining point and to receive wireless charging through the second vehicle.

12. An electric vehicle comprising:
a processor configured to request a wireless charging system to perform wireless charging and, when information related to a joining point in a platooning string is received from the wireless charging system, configured to control the electric vehicle to move to the joining point, to join the platooning string, and to receive wireless charging from a vehicle in front; and
a communication device configured to perform wireless communication with the wireless charging system and vehicles in the platooning string.

13. The electric vehicle of claim 12, wherein
the processor is configured to control the vehicle depending on a command of a leading vehicle of the platooning string when it joins the platooning string.

14. The electric vehicle of claim 12, wherein
the processor is configured to perform braking control simultaneously with the vehicles in the platooning string and to stop the wireless charging, when receiving an emergency braking command from the leading vehicle of the platooning string during wireless charging after the joining of the platooning string.

15. The electric vehicle of claim 12, wherein
the processor, depending on a first joining point and a second joining point received from the wireless charging system, is configured to control the vehicle to first move to the first joining point, to join the platooning string, and to receive first wireless charging from a vehicle in front, and when the first wireless charging is completed, to control the vehicle to leave the platooning string for a while, to move to a second joining point, to join the joining string, and to receive second wireless charging from a vehicle in front.

16. An electric vehicle. which performs platooning,
the electric vehicle configured to adjust an inter-vehicle distance for allowing a non-platooning electric vehicle to join a platooning string when receiving a request for the joining of the non-platooning electric vehicle and wireless charging from a wireless charging system during platooning.

17. The electric vehicle of claim 16, wherein
the electric vehicle readjusts the platooning string when the wireless charging is completed after the non-platoon electric vehicle joins the platooning string and it leaves the platooning string.

18. The electric vehicle of claim 16, wherein
the electric vehicle increases an inter-vehicle distance at a point which the non-platooning electric vehicle in the platooning string intends to join when the non-platooning electric vehicle joins the platooning string, receives first wireless charging, leaves the platooning string, and then wants to join the platooning string behind another vehicle in the platooning string for second wireless charging.

19. The electric vehicle of claim 18, wherein
the electric vehicle, while providing wireless charging to the non-populated electric vehicle, stops providing the wireless charging and performs emergency braking when an emergency braking command is received from a leading vehicle.
